(19) United States
(12) Patent Application Publication
(10) Pub. No.: US 2012/0003469 A1
(43) Pub. Date: Jan. 5, 2012

(54) SECURITY ELEMENT, PARTICULARLY SECURITY ELEMENT HAVING EVIDENCE OF MANIPULATION

(75) Inventors: Josef Riegler, Baumgartenberg (AT); Johann Hilburger, Pirk (DE); Marco Mayrhofer, Sierning (AT)

(73) Assignee: Hueck Folien Ges.M.B.H., Baumgartenberg (AT)

(21) Appl. No.: 13/139,827

(22) PCT Filed: Feb. 4, 2010
(86) PCT No.: PCT/EP10/00697

§ 371 Date: Aug. 4, 2011

(30) Foreign Application Priority Data
Mar. 27, 2009 (EP) 09004424.9

(51) Int. Cl. G09F 3/02; B32B 27/06

(52) U.S. Cl. 428/353; 428/354

(57) ABSTRACT

The invention relates to a security element, particularly as a security label, characterized in that said element comprises the following layers: a) a carrier substrate; b) a first paint coating comprising an optically active structure; c) a second paint coating; d) optionally a reflective layer and/or a layer having optical features; e) an adhesive layer.

The invention relates to a security element, more particularly a security label, which allows evidence of tampering.

The present invention relates in particular to security labels which have an optically active structure which is not visible in the intact state and which becomes perceptible only after an attempt at tampering.

From WO 01/93231 is a security label which has two microstructures, of which one is a diffractive structure perceptible even in the untampered state and the other is a release-controlling structure. In the event of an attempt at tampering, parts at least of a reflecting layer are detached, thus rendering visible a new, visually perceptible information item.

It was an object of the present invention to provide a security element, more particularly a security label, which allows evidence of tampering, the security feature being perceptible only in the event of tampering and being imperceptible in the untampered state.

In the tampered state, furthermore, on both surfaces, the security element is to have a smooth, nontacky surface.

The present invention accordingly provides a security element, more particularly in the form of a security label, characterized in that it has the following layers:

a) a backing substrate

b) a first varnish layer which has an optically active structure

c) a second varnish layer

d) optionally a reflecting layer and/or a layer having optical features

e) an adhesive coating.

There may optionally be an adhesion promoter layer sited between the layers a) and b).

By optically active structure here are meant, in particular, structures which are active through diffraction optics, such as holograms, surface reliefs, diffraction structures, diffraction gratings, kinegrams, and the like.

By a reflecting layer is meant here, in particular, a metallic layer or a layer with a metallic appearance.

By a layer having optical features is meant here, in particular, a colored layer or a layer having luminescence properties, more particularly fluorescence or phosphorescence properties.

The optical properties of the layer can also be influenced, however, by visible dyes and/or pigments, luminescent dyes and/or pigments, which fluoresce and/or phosphoresce in the visible range, in the UV range or in the IR range, or by effect pigments, such as liquid crystals, mother-of-pearl, bronzes and/or multilayer color-change pigments, and heat-sensitive inks and/or pigments. These components can be employed in all possible combinations. In addition, it is also possible for phosphorescent pigments to be used alone or in combination with other dyes and/or pigments.

Suitable backing substrates include, for example, backing films, preferably flexible polymeric films, made for example of PI, PP, MOPP, PE, PPS, PEEK, PEK, PEI, PSU, PAEK, LCP, PEN, PBT, PET, PA, PC, COC, POM, ABS, PVC, fluoropolymers, such as Teflon, and the like. The backing films preferably have a thickness of 5-700 μm, more preferably 5-200 μm, very preferably 5-100 μm.

As backing substrate it is also possible, furthermore, to use coextruded or chemically or physically pretreated polymeric films, examples being acrylate-coated polymeric films.

As backing substrate it is also possible, furthermore, to employ metal foils, examples being Al, Cu, Sn, Ni, Fe or stainless steel foils, having a thickness of 5-200 μm, preferably 10 to 80 μm, more preferably 20-50 μm. The films may also be surface-treated, coated or laminated with, for example, plastics, or varnished. As backing substrates it is also possible, furthermore, to use paper or composites with paper, examples being composites with plastics that have a basis weight of 20-500 g/m², preferably 40-200 g/m².

The backing substrate may optionally be coated with an adhesion promoter.

Applied to the backing substrate is a varnish layer b). This varnish layer may be a radiation-curable varnish layer or a thermoplastic varnish layer.

The radiation-curable varnish may be for example a radiation-curable varnish system based on a polyester system, on an epoxy system or polyurethane system that comprises two or more different photoinitiators, familiar to the skilled person, which are able to initiate curing of the varnish system to different degrees at different wavelengths. Thus, for example, one photoinitiator may be activatable at a wavelength of 200 to 400 nm, with the second photoinitiator then being activatable at a wavelength of 370 to 600 nm. Sufficient difference ought to be maintained between the activation wavelengths of the two photoinitiators, so that the second photoinitiator is not excited excessively while the first photoinitiator is being activated. The range in which the second photoinitiator is excited ought to lie within the transmission wavelength range of the backing substrate used. For the principal curing (activation of the second photo-initiator) it is also possible to use electron beams.

As radiation-curable varnish it is also possible to use a water-thinnable varnish. Polyester-based varnish systems are preferred.

The shaping of the surface structure, i.e., of the diffraction, scattering or relief structure, is accomplished, for example, at a controlled temperature by means of a die, or using an embossing mold, into the radiation-curable varnish layer which, through activation of the first photoinitiator, has been pre-cured to the gel point, and at the time of shaping is present in this state.

Where a water-thinnable radiation-curable varnish is used, preliminary drying may optionally be implemented beforehand, by means of IR emitters, for example.

The thermoplastic varnish, which is subsequently stabilized, is composed of a base of MMA or ethyl-cellulose or cycloolefin copolymer, the base polymer being admixed with modifiers in order to bring about the required thermoplastic properties and/or to bring about the subsequent stabilizability.

Depending on the base polymer, modifiers that are suitable include, for example, additives for setting the desired glass transition temperature, the range in which the varnish is in the thermoplastic state, or modifiers for achieving permanent curing of the varnish.

The components are preferably dissolved in a solvent—for example, in aqueous solvents, water, alcohols, ethyl acetate, methyl ethyl ketone, and the like, or mixtures thereof.

An MMA-based varnish is admixed, for example, with particular advantage, with nitrocellulose for increasing the glass transition temperature.

A varnish based on cycloolefin copolymers is admixed, for example, with particular advantage, with polyethylene waxes.

An ethylcellulose-based varnish is admixed, for the purpose of adjusting the curability, with commercially customary crosslinkers.

The concentration of the base polymer in the finished varnish, depending on the base polymer, on the desired properties of the varnish, and on the nature and concentration of the modifiers, is 4%-50%.

The structuring of the thermoplastic varnish may be accomplished by means of a conventional thermal embossing process.

The layer thickness of the applied varnish may vary in accordance with the requirements relating to the end product and thickness of the substrate, and amounts in general to between 0.5 and 50 μm, preferably between 2 and 10 μm, more preferably between 2 and 5 μm.

Applied atop this varnish layer b), then, is a further varnish layer c), which may have a composition the same as or different to that of the first varnish layer b).

This varnish layer c) may optionally have a second optically active structure.

As a result, the optically active structure introduced into the first varnish layer b) is extinguished, i.e., becomes invisible.

Subsequently, atop this second varnish layer c), optionally, a reflecting layer or a layer having optical properties is applied.

This reflecting layer may be composed of a metal, a metal compound, or an alloy. As a metal layer, layers of Al, Cu, Fe, Ag, Au, Cr, Ni, Zn, and the like are suitable. As metal compounds, for example, oxides or sulfides of metals, more particularly TiO₂, Cr oxides, ZnS, ITO, ATO, FTO, ZnO, Al₂O₃ or silicon oxides, are suitable. Suitable alloys are, for example, Cu—Al alloys, Cu—Zn alloys, and the like.

The layer may be applied comprehensively or partially.

Furthermore, a layer having optical features may be applied.

This layer may be applied comprehensively or partially.

In one particular embodiment, both a metallic layer and a layer having optical properties may be applied, the layers being applied comprehensively or partially, register-accurately and/or fit-accurately or at least partially overlappingly.

Atop this construction is applied an adhesive coating, preferably a self-adhesive coating, cold-seal adhesive coating or a hot-seal adhesive coating.

With this adhesive coating, the security element is fastened to the article that is to be secured.

Where the construction is applied by means of a self-adhesive coating or a cold-seal coating to an item that is to be secured, the adhesion between the layers a and b must be greater than the adhesion between the layers b and c.

In the case of use as a transfer element and of application by means of a hot-seal adhesive coating, in contrast, the adhesion between the layers a and b is lower than the adhesion between the layers b and c.

In the event of an attempt at tampering, more particularly in an attempt to remove the film or label from the item that is to be secured, the first varnish layer b) is separated from the second varnish layer c), and the optically active structure introduced into the first varnish layer b) becomes perceptible as a negative image both in the first (removed) varnish layer and in the second varnish layer (which remains on the item to be secured).

If the security element is applied in the form of a transfer element to the article that is to be secured, the authenticity can be evidenced by means of an auxiliary agent, as for example by means of the so-called Tesa test. For this purpose, an adhesive strip is applied to the security element and then removed. The optically active structure introduced into the first varnish layer becomes perceptible as a negative image not only on the adhesive strip but also in the varnish layer which remains on the item that is to be secured.

Moreover, the surface of the varnish layer which remains on the article that is to be secured, like the surface of the part removed, is smooth and dry and does not have a tacky feel (dry peel effect).

The security element of the invention can be applied as a security element to packing materials or can be used in converted form as labels in any desired shape (angular, circular, oval) or as adhesive tape for securing articles or packaging.

### EXAMPLE

Label constructions

a) Polyester film 36 μm
Adhesion promoter
UV-curable varnish layer with hologram embossing 2 μm
UV-curable colored varnish layer 2 μm
Self-adhesive coating

b) Polyester film 50 μm
UV-curable varnish layer with hologram embossing 2 μm
UV-curable varnish layer with hologram embossing 4 μm
Metallic layer Al, 200 nm.
Hot-seal coating

c) Coextruded polyester film 12 μm
UV-curable varnish layer, colored, with hologram embossing 2 μm
UV-curable varnish layer, differently colored 4 μm
Luminescent coating
Self-adhesive coating

d) Pretreated PP film 23 μm
UV-curable varnish layer with hologram embossing 20 μm
UV-curable varnish layer with hologram embossing 4 μm
Metallic layer Cu, 50 μm
Self-adhesive coating

e) Polyester film 100 μm
Adhesion promoter
Thermoplastic varnish layer with hologram embossing 2 μm
UV-curable varnish layer with hologram embossing 4 μm
Metallic layer Al 100 nm partial
Luminescent coating partial or comprehensive
Self-adhesive coating

f) Polyester film 100 μm
Adhesion promoter
UV-curable varnish layer with hologram embossing 2 μm
Thermoplastic varnish layer with hologram embossing 4 μm
Metallic layer Al 100 nm partial
Luminescent coating partial or comprehensive
Self-adhesive coating

g) Polyester film 100 μm
Adhesion promoter
Thermoplastic varnish layer with hologram embossing 4 μm
Thermoplastic varnish layer with hologram embossing 4 μm
Metallic layer Al 120 nm partial
Luminescent coating partial or comprehensive
Self-adhesive coating

1. A security element, more particularly in the form of a security label, characterized in that it has the following layers:
a) a backing substrate
b) a first varnish layer which has an optically active structure
c) a second varnish layer
d) optionally a reflecting layer and/or a layer having optical features
e) an adhesive coating.

2. The security element of claim 1, characterized in that a polymeric film, metal foil or paper, or composites with paper, is used as backing substrate.

3. The security element of claim 1, characterized in that a chemically or physically pretreated, or coextruded, polymeric film is used as backing substrate.

4. The security element of claim 1, characterized in that an adhesion promoter is applied between the layers a and b.

5. The security element of claim 1, characterized in that the second varnish layer has an optically active structure.

6. The security element of claim 1, characterized in that the optically active structure of the second varnish layer is different to the optically active structure of the first varnish layer.

7. The security element of claim 1, characterized in that the reflecting layer and/or the layer having optical features are applied fit-accurately, register-accurately or at least partially overlappingly with respect to one another.

8. The security element of claim 1, characterized in that the adhesion between the layers a and b is greater than the adhesion between the layers b and c.

9. The security element of claim 1, characterized in that the adhesion between the layers a and b is less than the adhesion between the layers b and c.

10. The security element of claim 1, characterized in that the first and/or second varnish layers are (a) radiation-curable varnish layer(s).

11. The security element of claim 1, characterized in that the first and/or second varnish layers are (a) thermoplastic varnish layer(s).

12. The security element of claim 1, characterized in that the adhesive coating is a self-adhesive, cold-seal or hot-seal coating.

13. The use of the security element of claim 1 for security labels, adhesive tapes or security films.
